(19) United States
(12) Patent Application Publication
(10) Pub. No.: US 2014/0134930 A1
(43) Pub. Date: May 15, 2014

(54) DEBURRING DEVICE

(71) Applicants: HON HAI PRECISION INDUSTRY CO., LTD., New Taipei (TW); FU DING ELECTRONICAL TECHNOLOGY (JIASHAN) CO.,LTD., Zhejiang (CN)

(72) Inventors: HUA-WEI CHEN, Jiashan (CN); YONG-HUA ZHANG, Jiashan (CN)

(73) Assignees: HON HAI PRECISION INDUSTRY CO., LTD., New Taipei (TW); FU DING ELECTRONICAL TECHNOLOGY (JIASHAN) CO.,LTD., Zhejiang (CN)

(21) Appl. No.: 14/069,375

(22) Filed: Nov. 1, 2013

(30) Foreign Application Priority Data
Nov. 14, 2012 (CN) 2012205982578

(51) Int. Cl. B23C 3/12

(52) U.S. Cl. CPC B23C 3/124
USPC 451/70

(57) ABSTRACT

A deburring device, for removing burrs off an inner sidewall of a hole of a workpiece, includes a mounting seat, a first driving member, an elastic coupler, a cutter, a polisher assembly, an elastic coupler, and a controller. The first driving member is mounted on the mounting seat. The cutter is connected to the first driving member by the elastic coupler. The polishing assembly is assembled to the mounting seat and arranged opposite to the cutter, in which the controller is electrically connected to the first driving member and the polisher assembly. The controller controls the cutter to enter the hole of the workpiece and mill the inner sidewall of the hole of the workpiece to remove burrs off the workpiece, the polishing pad moves to remove burrs generated by the cutter.

### BACKGROUND

1. Technical Field

The present disclosure relates to a deburring device.

2. Description of Related Art

A workpiece with a hole may have burrs on an inner sidewall of the hole thereof. A deburring device may be employed to machine the inner sidewall of the workpiece for removing the burrs from the inner sidewall of the workpiece. The deburring device includes a driving member and a cutter connected to the driving member. The driving member drives the cutter to enter into the hole to remove the burrs. A counter-acting force of the inner sidewall of the workpiece may act on the cutter to make the cutter deviate from a preset position. Thus, when the cutter removes the burrs, it may hurt the inner sidewall of the workpiece due to the deviation travel of the cutter. In addition, burrs may be generated by the cutter when removing the burrs off from the inner sidewall of the hole of the workpiece.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a deburring device.

FIG. 2 is a partial, isometric view of the deburring device of FIG. 1.

### DETAILED DESCRIPTION

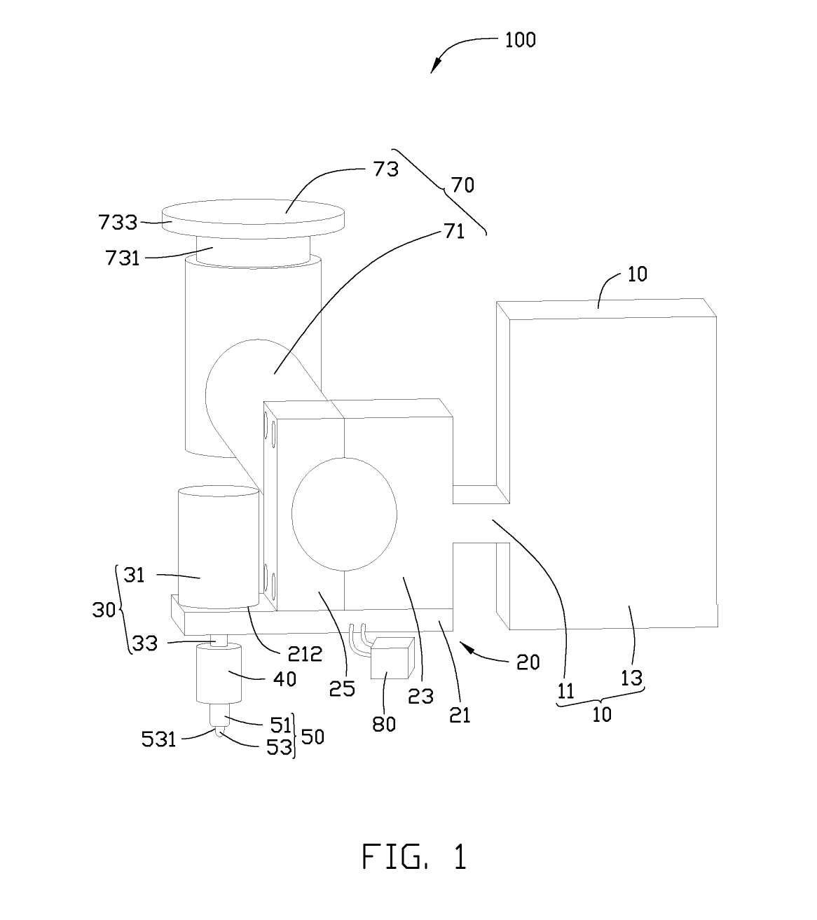

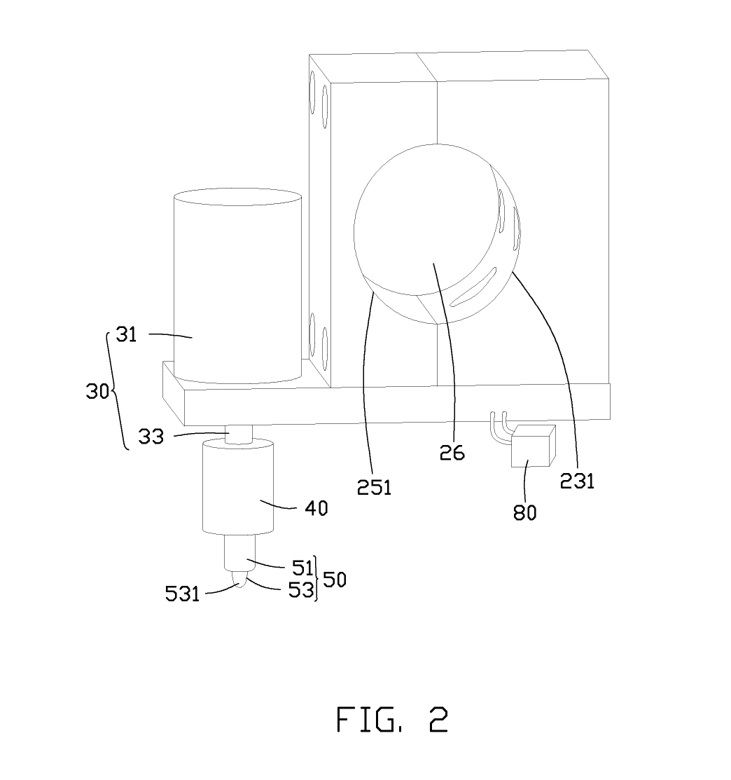

FIGS. 1 and 2 show an embodiment of a deburring device 100 for removing burrs on an inner sidewall of a hole of a workpiece (not shown). The deburring device 100 includes a moving device 10, a mounting seat 20, a first driving member 30, an elastic coupler 40, a cutter 50, a polisher assembly 70, and a controller 80. The mounting seat 20 is connected to the moving device 10; the first driving member 30 extends through the mounting seat 20; and the cutter 50 is connected to the first driving member 30 via the elastic coupler 40. The polisher assembly 70 is mounted on the mounting seat 20 away from the cutter 50. The controller 80 is electrically connected to the moving device 10, the first driving member 30, and the polisher assembly 70, respectively.

The moving device 10 includes a connecting member 11, and a driving member 13 connected to the connecting member 11. The driving member 13 rotates the connecting member 11 to rotate the mounting seat 20. In the illustrated embodiment, the moving device 10 is a robot arm. The moving device 10 may be other driving assembly, such as a pneumatic cylinder.

The mounting seat 20 is fixedly connected to the connecting member 11 of the moving device 10. The mounting seat 20 includes a supporting portion 21, a first mounting portion 23, and a second mounting portion 25. The supporting portion 21 is substantially a rectangular plate, and defines an insert hole 212 on a side thereof. The first mounting portion 23 and the second mounting portion 25 are mounted on the supporting portion 21 side by side. The first mounting portion 23 is located at a side of the supporting portion 21 away from the insert hole 212, and is connected to the connecting member 11. The second mounting portion 25 is arranged between the insert hole 212 and the first mounting portion 23. The first mounting portion 23 defines a first groove 231 thereon facing the second mounting portion 25. The second mounting portion 25 is mounted to the supporting portion 21 and connected to the first mounting portion 23. The second mounting portion 25 defines a second groove 251 facing the first mounting portion 23. The first groove 231 and the second groove 251 cooperatively define a substantially circular mounting hole 26.

The first driving member 30 is mounted on the supporting portion 21 and aligned to the insert hole 212. The first driving member 30 includes a driving body 31 and an output shaft 33 connected to the driving body 31. The driving body 31 is located above the insert hole 212, while the output shaft 33 extends through the insert hole 212 and exposes below the insert hole 212.

The elastic coupler 40 is connected to a distal end of the output shaft 33 away from the driving body 31. The cutter 50 is assembled to the elastic coupler 40. The elastic coupler 40 deforms to eliminate displacement between the cutter 50 and the first driving member 30, as well as to be buffering and absorbing vibration between the cutter 50 and the inner sidewall of the hole of the workpiece. The elastic coupler 40 is employed to buffer collision between the cutter 50 and the inner side of the hole of the workpiece.

The cutter 50 includes an arbor 51, and a cutting portion 53 axially protruding from an end of the arbor 51. The arbor 51 is substantially cylindrical, and connected to the elastic coupler 40 with an end thereof away from the cutting portion 53. The first driving member 30 drives the cutter 50 to rotate relative to the mounting seat 20 to remove burrs. The cutting portion 53 is in a cone shape, and includes at least one cutting edge 531 on a periphery of the cutting portion 53. The at least one cutting edge 531 is inclined to an axis of the arbor 51. In the illustrated embodiment, an end of the cutting portion 53 adjacent to the arbor 51 has a diameter less than that of the hole of the workpiece. The cutting portion 53 is received in the hole of the workpiece, and the cutting edge 531 removes burrs.

The polisher assembly 70 is perpendicularly assembled to the mounting seat 20, and away from the cutter 50. The polisher assembly 70 includes a second driving member 71 and a polishing pad 73 connected to the second driving member 71. The second driving member 71 is fixedly assembled into the mounting hole 26 of the mounting seat 20 with an end thereof, and is perpendicular to an axis of the cutter 50. The polishing pad 73 is substantially a stepped cylindrically pad, and arranged opposite to the cutter 50. The polishing pad 73 includes a connecting portion 731 and a polishing portion 733 coaxially connected to the connecting portion 731. The polishing portion 733 has a diameter greater than that of the connecting portion 731. The second driving member 71 rotates the polishing pad 73, and the moving device 10 drives the polisher assembly 70 to polish an end of the hole, thereby removing burrs generated by the cutter 50 on the end of the hole.

The controller 80 is electrically connected to the first driving member 30, the polisher assembly 70, and the moving device 10. Being controlled by the controller 80, the first driving member 30 drives the cutter 50 to deburr the workpiece, and the second driving member 71 drives the polishing pad 73 to remove burrs on the end of the hole of the workpiece generated by the cutter 50. The moving device 10 rotates the mounting seat 20 to move the polisher assembly 70 after the cutter 50.

When in assembly, the moving device 10 is connected to the supporting portion 21. The driving body 31 is fixed to the supporting portion 21 above the insert hole 212, the output shaft 33 extends through the insert hole 212. Opposite ends of the elastic coupler 40 are connected to the output shaft 33 and the arbor 51 of the cutter 50, respectively. Then the second driving member 71 is fixedly assembled into the mounting hole 26 of the mounting seat 20. The second mounting portion 25 is assembled to the first mounting portion 23. The controller 80 is electrically connected to the moving device 10, the first driving member 30, and the polisher assembly 70, respectively.

When in use, the controller 80 controls the first driving member 30 to rotate the cutter 50, the cutting portion 53 of the cutter 50 enters into the hole of the workpiece, and mills the inner sidewall (at the hole) of the workpiece to remove burrs off from the workpiece. Then, the moving device 10 rotates the mounting seat 20 to move the polisher assembly 70. The controller 80 controls the second driving member 71 to drive the polishing pad 73 to remove burrs generated by the cutter 50.

The cutter 50 is connected to the first driving member 30 via the elastic coupler 40, thus the elastic coupler 40 is capable of deforming to eliminate deviation between the cutter 50 and the first driving member 30, and buffering and absorbing vibration, thereby preventing the cutter 50 from damaging the inner sidewall of the workpiece. In addition, the moving device 10 is capable of driving the polisher assembly 70 to remove burrs generated by the cutter 50, thereby enhancing a finish appearance of the inner sidewall of the workpiece.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A deburring device, for removing burrs from an inner sidewall of a hole of a workpiece, the deburring device comprising:
a mounting seat
a first driving member mounted on the mounting seat;
an elastic coupler;
a cutter connected to the first driving member by the elastic coupler;
a polisher assembly assembled to the mounting seat and aligned away from the cutter; and
a controller electrically connected to the first driving member and the polisher assembly to control the first driving member and the polisher assembly, respectively, wherein, the cutter is capable of entering into the hole of the workpiece and milling the inner sidewall of the workpiece to remove burrs off the workpiece, the polisher assembly moves to remove burrs generated by the cutter, when being controlled by the controller, respectivley.

2. The deburring device of claim 1, further comprising a moving device electrically connected to and controlled by the controller, wherein the mounting seat is fixedly connected to the moving device, and the moving device rotating the mounting seat, thereby moving the polisher assembly toward the hole.

3. The deburring device of claim 2, wherein the moving device comprises a connecting member and a driving member connected to the connecting member, the connecting member is fixedly connected to the mounting seat, and the driving member rotates the mounting seat via the connecting member.

4. The deburring device of claim 1, wherein the cutter comprises an arbor and a cutting portion axially protruding from an end of the arbor, the arbor is connected to the elastic coupler.

5. The deburring device of claim 4, wherein the cutting portion of the cutter comprises at least one cutting edge on a periphery of the cutting portion, the at least one cutting edge is rotated by the first driving member to remove burrs.

6. The deburring device of claim 1, the first driving member comprises a driving body and an output shaft connected to the driving body, the driving body is mounted on the mounting seat, the output shaft extends through the mounting seat and connects with the elastic coupler.

7. The deburring device of claim 1, wherein the mounting seat comprises a supporting portion, a first mounting portion, and a second mounting portion, the supporting portion defines an insert hole on a side thereof, the first mounting portion is mounted at a side of the supporting portion away from the insert hole, the second mounting portion is arranged between the insert hole and the first mounting portion, and is fixedly connected to the first mounting portion, the first driving member is assembled into the insert hole, the polisher assembly is held between the first mounting portion and the second mounting portion.

8. The deburring device of claim 7, wherein the second mounting portion defines a second groove facing the first mounting portion, the first groove and the second groove cooperatively form a mounting hole for holding the polisher assembly.

9. The deburring device of claim 7, wherein the polisher assembly comprises a second driving member and a polishing pad connected to the second driving member, the second driving member is fixedly held between the first mounting portion and the second mounting portion of the mounting seat, the second driving member rotates the polishing pad to polish the workpiece.

10. The deburring device of claim 9, wherein the polishing pad comprises a connecting portion and a polishing portion coaxially connected to the connecting portion, the polishing portion has a diameter greater than that of the connecting portion, the second driving member rotates the polishing pad via the connecting portion.

11. A deburring device, for removing burrs from an inner sidewall of a hole of a workpiece, the deburring device comprising:
a moving device;
a mounting seat connected to the moving device;
a first driving member mounted on the mounting seat;
a cutter connected to the first driving member;
a polisher assembly held by the mounting seat; and
a controller connected to the first driving member, the moving device, and the polisher assembly to control the driving member, the moving device, and the polisher assembly, respectively, wherein the moving device moves the mounting seat to drive the cutter entering into the hole of the workpiece, the first driving member rotates the cutter to mill the inner sidewall of the hole of the workpiece to remove burrs from the workpiece, the moving device rotates the mounting seat to enable the polisher assembly to move and remove burrs generated by the cutter, when being controlled by the controller, respectively.

12. The deburring device of claim 11, further comprising an elastic coupler, the cutter is connected to the first driving member by the elastic coupler, the polisher assembly is arranged opposite to the cutter.

13. The deburring device of claim 11, wherein the moving device comprises a connecting member and a driving member connected to the connecting member, the connecting member is connected to the mounting seat, and the driving member rotates the mounting seat via the connecting member.

14. The deburring device of claim 12, wherein the cutter comprises an arbor and a cutting portion axially protruding from an end of the arbor, and the arbor is connected to the elastic coupler.

15. The deburring device of claim 14, wherein the cutting portion is in a cone shape and comprises at least one cutting edge on a periphery thereof, and the at least one cutting edge is rotated by the first driving member to remove burrs.

16. The deburring device of claim 11, the first driving member comprises a driving body and an output shaft connected to the driving body, the driving body is mounted on the mounting seat, the output shaft extends through the mounting seat and connects with the elastic coupler.

17. The deburring device of claim 11, wherein the mounting seat comprises a supporting portion, a first mounting portion, and a second mounting portion, the supporting portion defines an insert hole on a side thereof, the first mounting portion is mounted at a side of the supporting portion away from the insert hole, the second mounting portion is arranged between the insert hole and the first mounting portion, and fixedly connected to the first mounting portion, the first driving member is assembled into the insert hole, the polisher assembly is held between the first mounting portion and the second mounting portion.

18. The deburring device of claim 17, wherein the second mounting portion defines a second groove facing the first mounting portion, the first groove and the second groove cooperatively form a mounting hole for holding the polisher assembly.

19. The deburring device of claim 17, wherein the polisher assembly comprises a second driving member and a polishing pad connected to the second driving member, the second driving member is held between the first mounting portion and the second mounting portion, the second driving member rotates the polishing pad to polish the workpiece.

20. The deburring device of claim 19, wherein the polishing pad comprises a connecting portion and a polishing portion coaxially connected to the connecting portion, the polishing portion has a diameter greater than that of the connecting portion, the second driving member rotates the polishing pad via the connecting portion
